(19) United States
(12) Patent Application Publication
(10) Pub. No.: US 2005/0050330 A1
(43) Pub. Date: Mar. 3, 2005

(54) Security token

(76) Inventors: Leedor Agam, Ramat Aviv (IL); Yanki Margalit, Ramat Gan (IL); Dany Margalit, Ramat Gan (IL)

Correspondence Address: John F. Letchford;Klehr, Harrison, Harvey, Branzburg & Ellers, 260 South Broad Street, Philadelphia, PA, 19102, US

(21) Appl. No.: 10/649,169

(22) Filed: Aug. 27, 2003

(51) Int. Cl. H04L 9/00

(52) U.S. Cl. 713/172

(57) ABSTRACT

A security token, a security system and a method for authenticating a client are disclosed. The security token including a one-time password mechanism, for rendering one-time password functionality; a public-key mechanism, for rendering public-key functionality with respect to the one-time password functionality; and wired communication means with a host, for connecting the security token to the host and for providing the security token the power supply required for operating at least the public-key mechanism, thereby enabling rendering one-time password functionality and/or public-key functionality by the security token.

### FIELD OF THE INVENTION

The present invention relates to the field of security tokens. More particularly, the invention relates to a security token that enables both OTP and PKI functionality, and the combination thereof.

### BACKGROUND OF THE INVENTION

OTP, the acronym of One-Time Password, refers in the prior art to a password that is valid only for a single session, i.e. differs each time it is requested or generated. Using OTP methods, passwords that have been “stolen” by eavesdropping on a network are actually useless. Therefore, OTP are commonly used in security systems in which a user has to be authenticated to a server.

For example, the “RSA SecurID” is a mobile device which generates a pseudo-random string per minute, and displays it on a built-in display. Whenever a user is asked to enter a password into a system, he types the password which is presented on the display of the RSA SecurID security token.

The common way OTP tokens operate is as follows: the one-time password is displayed on a built-in display on the token. The user has to provide to the host his PIN and the password which is displayed at that moment on the OTP token. This is usually carried out by typing the data on a keyboard connected to the host. Another problem regarding OTP tokens is that they use their own power source, i.e. a battery, which involves some inconvenience since they should be replaced from time to time.

Since in the current OTP tokens the same key is used in both the token and the server (“symmetric key”), using the same key for more than one application is risky.

Another developing technology in the security token field is the PKI (Public Key Infrastructure) token technology, e.g. the RSA and ECC. The PKI technology is based on asymmetric keys, contrary to how the OTP is implemented, i.e. based on symmetric keys. The PKI technology enables the use of a token not only as an authentication device, but also as a “security engine”, i.e. a device which performs a variety of security-related functionality, such as encryption, decryption, digital signature, and so forth.

From the practical aspect, PKI requires much more processing power than OTP. The problem becomes extremely acute when dealing with 1024 bit keys and higher, e.g. 2048 bit keys. Therefore OTP tokens can be easily implemented as mobile devices, contrary to PKI tokens, which are typically plugged into another device, through which they are connected to an external power source.

From the application aspect, applications that use OTP tokens are very limited, and consequently OTP tokens are used mainly for remote access, network logon, etc. The PKI token technology may be used for a variety of implementations, e.g., a variety of authentication schemes, rendering digital signatures, encryption and decryption, secure e-mail, and so forth.

An organization that already uses the OTP tokens for its purposes and wishes to expand the use by adding PKI tokens, has to deal with two major problems: From the server point of view there are logistical problems like holding two separate data bases. From the user point of view there is a great deal of inconvenience, since the user has to hold at least two tokens, an OTP token and a PKI token.

It is therefore an object of the present invention to provide a security token, which supports both the OTP token technology and the PKI technology, and the combination thereof, thereby gaining the functionality of both, the OTP functionality and the PKI functionality, and the combination thereof.

It is another object of the present invention to provide a security token, which achieves a better level of security than that provided by each technology separately.

It is a further object of the present invention to provide a security token which is more user friendly than an OTP token and a PKI token.

It is a still further object of the present invention to provide a security system, which enables the use of the same database of keys for both the OTP and the PKI functionality.

Other objects and advantages of the invention will become apparent as the description proceeds.

In this matter, it should be mentioned that although behind the SecurID stands the RSA Company, the enterprise that invented the famous public-key algorithm “RSA”, the RSA Company doesn't manufacture any security token which uses public keys for creating OTP values, nor do they manufacture a device that combines the PKI technology with OTP technology in an offline mode, i.e. display an OTP value on an LCD, when not connected to the PC.

### SUMMARY OF THE INVENTION

In one aspect, the present invention is directed to a security token, comprising: one-time password mechanism, for rendering one-time password functionality; public-key mechanism, for rendering public-key functionality with respect to the one-time password functionality; and wired communication means with a host, for connecting the security token to the host and for providing the security token the power supply required for operating at least the public-key mechanism; whereby enabling rendering one-time password functionality and/or public-key functionality by the security token.

In a second aspect, the present invention is directed to an OTP security token, for securely providing a one-time (e.g. the real-time, the value of a counter, a list of random numbers, etc.) value to a host system, the OTP security token comprising: means for generating said one-time value; a PKI mechanism for performing public-key functionality with respect to said one-time value; and communication means with said host, for providing said encrypted one-time value to said host.

In a third aspect, the present invention is directed to a security system comprising: one or more security tokens, each of which comprising: one-time password mechanism, for rendering one-time password functionality; public-key mechanism, for rendering public-key functionality with respect to the one-time password functionality; and wired communication means with a host, for connecting the security token to the host and for providing the security token the power supply required for operating at least the public-key mechanism. The system comprises a host system, comprising: a one-time password mechanism, corresponding to the one-time password mechanism of the security tokens, for rendering one-time password functionality; a public-key mechanism, corresponding to the public-key mechanism of the security tokens, for rendering public-key functionality; communication means, corresponding to the communication means of the security tokens, for communicating with the security tokens and for providing to a token the power supply required for operating at least the public-key mechanism of the security token.

In the fourth aspect, the present invention is directed to a method for authenticating a client by a host system, comprising: At the client side: (a) generating a first one-time value; (b) performing public-key functionality with respect to the one-time value; (c) providing the value to the host system. At the host system side: (d) performing public-key functionality which corresponds to the public key functionality performed at step (b) with the provided value; (e) generating a second one-time value in substantially the same manner as the first one-time value is generated; authenticating the client by the correspondence of the second value to the first value; whereby obtaining a better security level of authenticating the client.

### BRIEF DESCRIPTION OF THE DRAWINGS

The present invention may be better understood in conjunction with the following figures:

FIG. 1 schematically illustrates an authentication process carried out by an OTP token, according to the prior art.

FIG. 2 schematically illustrates an authentication process carried out by an OTP token, according to a preferred embodiment of the invention.

FIG. 3 schematically illustrates a security system, according to one embodiment of the invention.

FIG. 4 visually illustrates a security token, according to a preferred embodiment of the invention.

### DETAILED DESCRIPTION OF PREFERRED EMBODIMENTS

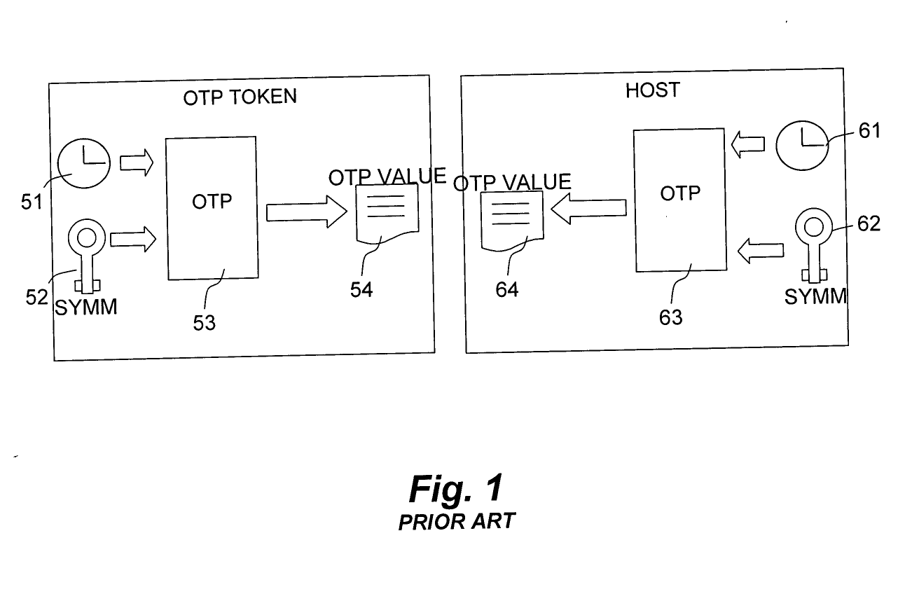

FIG. 1 schematically illustrates an authentication process carried out by an OTP token, according to the prior art.

At the token side: The one-time value 51 (illustrated by a real time clock) and the symmetric key 52 are used by a process 53 to generate a one-time password 54. The one-time password 54 is displayed on a display embedded within the token. The one-time password is provided to the host by typing its content on input means, e.g. keypad, connected to the host.

At the host side: The one-time value 61 (which should correspond to the one-time value 51) and the symmetric key 62 (which should be the same as key 52) are used by a process 63 (which should be the same as the process 53) to generate a one-time password 64. If the generated one-time password 64 corresponds to the one-time password 54 which has been generated by the token, then the authentication is considered as positive.

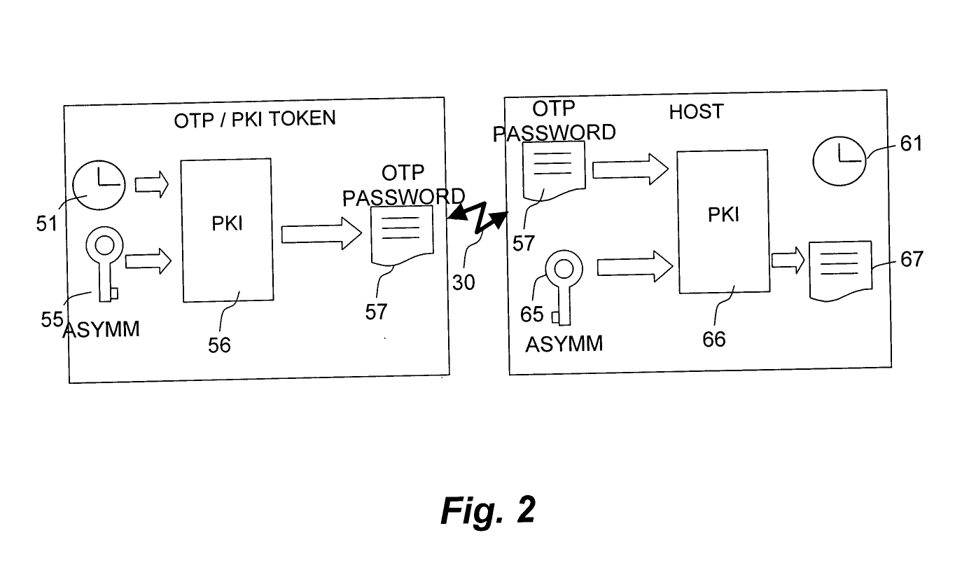

FIG. 2 schematically illustrates an authentication process carried out by an OTP token, according to a preferred embodiment of the invention.

At the token side: The one-time value 51 (illustrated by a real time clock) is encrypted by the PKI module 56 with the asymmetric key 55, generating the encrypted one-time value 57, which is provided to the host.

At the host side: The one-time value 57 which has been received from the token via communication means 30 is decrypted by the asymmetric key 65 (which corresponds to the asymmetric key 55) by the PKI module 66, resulting with a one-time password 67. If the one-time value 67 corresponds to the expected value, then the authentication is considered as positive. Communication means 30 preferably permits both wired and wireless connectivity between the token and host. In the event the token and host perform PKI operations, communication means 30 will be a wired connection directly between the host and token as described hereinafter. If only OTP functionality is desired, the connection provided by communication means 30 may be wireless.

Those skilled in the art will appreciate that in addition to the authenticating method described herein there may be other authentication methods which combines OTP and PKI. The method described herein is only an example of the variety of possibilities opened by combining the OTP technology with the PKI technology. For example, instead of encrypting and decrypting the one-time value as described in FIG. 2, a digital signature (or digital certificate) can be added to the one-time value 57, even without using encryption. Thus, module 56 performs some PKI-related activity in conjunction with the security of the one-time value, and module 66 performs some PKI-related activity which corresponds to the PKI-related activity of module 56.

It should be noted that the provided value doesn't necessarily equal the expected value, but should “correspond” to the expected value. For example, if the one-time value is the real time, and if the difference between the value 57 and the value 67 is less than, e.g., one minute, then the authentication can be considered as positive. It should also be noted that the clock of the token may not be tuned exactly to the clock of the host, and therefore a slight difference between the time of the host and the time provided by the token should be taken into consideration.

Another one-time mechanism known in the art is the counter. Each time a password is provided, the value of the counter is increased by one or another predetermined portion, not necessarily linear. Of course, this other one-time mechanism can be implemented for this purpose, e.g. a list of random numbers.

A counter mechanism may be implemented by a button installed on the token. Each time the user clicks on the button, the counter is increased, and a new one-time value is generated and displayed on the display. Since the user can push the button unintentionally, the value of the counter of the token and the value of the counter on the host may not be equal, but just “correspond”, i.e. they have a difference of not more than, for example, 10. Thus, the host checks not only the current value of the counter, but also the next 10 values to be generated.

According to a preferred embodiment of the invention, the key 55 is the public key of the host, while the key 65 is the corresponding private key. According to another preferred embodiment of the invention, key 55 is the private key of the token, while key 65 is the corresponding public key.

It is obvious that more sophisticated encryption/decryption schemes may be used. For example, encrypting the one-time value with a symmetric key, and then encrypting the result with a private key.

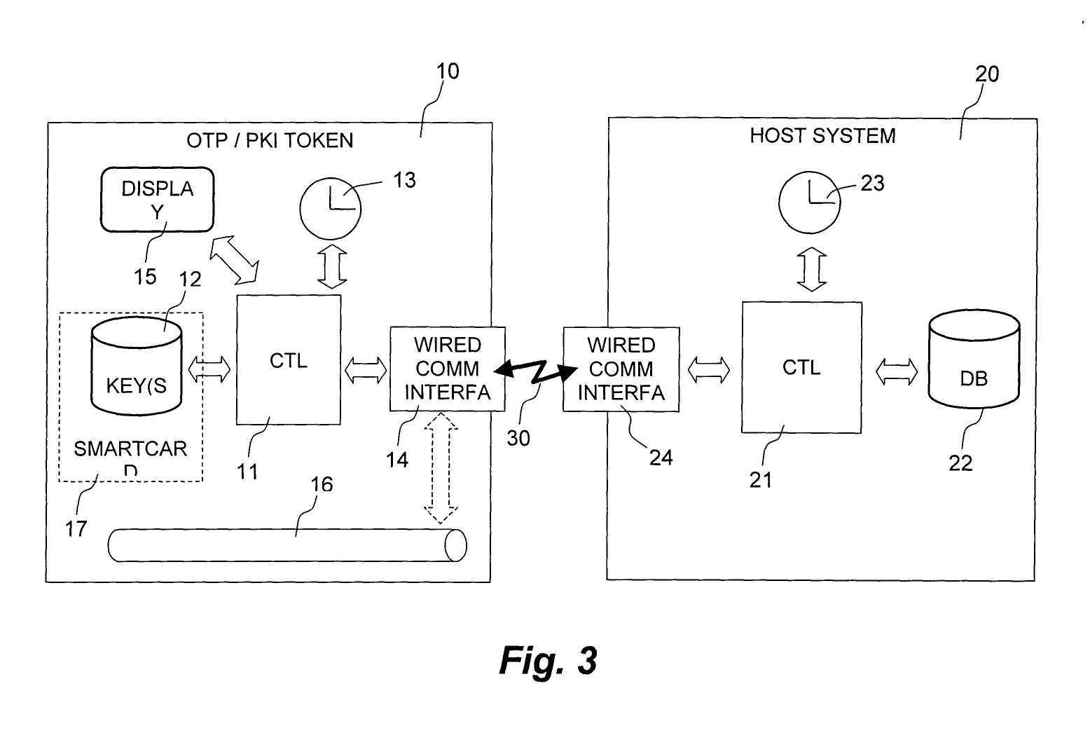

FIG. 3 schematically illustrates a security system, according to one embodiment of the invention. An OTP/PKI token 10 (the client) is connected to a host system 20 (the server) by wired communication 30.

The token 10 comprises:
A controlling module 11, for performing the PKI and OTP functionality, and for controlling/managing the operation of the token. The controlling module can be embodied as a CPU, memory and appropriate software.
One or more keys 12, for the OTP/PKI functionality.
A one time value generator 13, e.g. a real time clock, a counter or another element that changes each time it is accessed (e.g. a list of random numbers), for generating a one-time value.
Wired communication interface 14, for communicating with the host 20.
A display 15, for displaying one-time passwords.
A power supply 16, e.g. a battery, for providing the power supply for operating the token. A preferred power supply is a power source that is chargeable by the power supplied via the wired communication interface 14 of token 10 and the corresponding wired communication interface 24 of the host 20 which provides power for operating the security token when the token is disconnected from the host.

According to a preferred embodiment of the invention, at least the keys 12 may be stored within a smartcard 17, which provides a relatively high security level. Typically, smartcards are also a processing unit coupled with memory, and therefore they may perform other functionality, e.g. the functionality of the controlling module 11, the PKI, and so forth.

The host 20 comprises:
A controlling module 21, for performing the PKI/OTP functionality. The functionality of the controlling module 21 can be carried out as a part of the operating system of the host 20, by an application executed on the host 20, and so forth.
A database 22, for storing the keys, user ID of the authorized users, and so forth, in relevance with the OTP/PKI.
A one time value generator 23, e.g. a real time clock, a counter, a random list or another element that provides a different value each time it is accessed, corresponding to the one-time value generator 13 of the token 10.
Wired communication interface 24, corresponding to the wired communication 14 of the token 10.

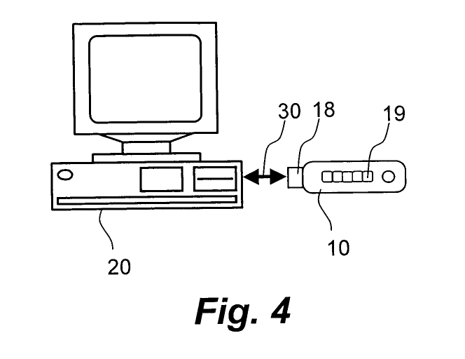

FIG. 4 visually illustrates a security token, according to a preferred embodiment of the invention. The display 19 of the token 10 displays the one-time password, like in the prior art. The traditional way of providing the one-time password is by typing the displayed value onto the input means of the host 20, e.g. a keypad. According to a preferred embodiment of the present invention, instead of typing the password, the user inserts the connector 18 (e.g. a universal serial bus (USB) plug) to the corresponding socket of the host, and the token interacts with the host via the communication channel 30 (whether wired or wireless), for providing the one-time password.

Those skilled in the art will appreciate that the invention can be embodied by other forms and ways, without losing the scope of the invention. The embodiments described herein should be considered as illustrative and not restrictive.

1. A security token, comprising:
a one-time password mechanism, for rendering one-time password functionality;
a public-key mechanism, for rendering public-key functionality with respect to said one-time password functionality; and
communication means for connecting said security token to said host and for providing to said security token the power supply required for operating at least said public-key mechanism.

2. A security token according to claim 1, further comprising a display, for displaying at least said one-time password.

3. A security token according to claim 1, further comprising a smartcard chip, for secure storage of keys and for rendering security-related functionality.

4. A security token according to claim 1, wherein said one-time password mechanism comprise means for generating a one-time value, said means selected from a group comprising: a real-time clock, and a counter.

5. A security token according to claim 1, wherein said communication means is selected from a group comprising: a display for displaying the password and thereafter manually providing the displayed value to a host, means for connecting said security token to said host via a wired connection, and means for connecting said security token to said host via a wireless connection.

6. A security token according to claim 5, wherein said wired communication means further comprise means for providing a power supply to said security token.

7. A security token according to claim 5, further comprising a chargeable power source, to be charged by the power supplied via said communication means, for providing the power for operating said security token while not connected to said host.

8. A one-time password security token, for securely providing a one-time value to a host system, said one-time password security token comprising:
means for generating said one-time value;
a public-key infrastructure mechanism, for performing public-key functionality with respect to said one-time value; and
communication means for connecting said security token with said host and for providing said encrypted one-time value to said host.

9. A one-time password security token according to claim 8, wherein said public-key functionality with respect to said one-time value is selected from a group comprising: encrypting said one-time value by said public-key functionality, and digitally signing said one-time password.

10. A one-time password security token according to claim 8, further comprising a display, for displaying at least the encrypted one-time value.

11. A one-time password security token according to claim 8, further comprising a smartcard chip, for rendering security-related functionality.

12. A one-time password security token according to claim 8, wherein said one-time value is selected from a group comprising: the real-time, the value of a counter, and a group of random numbers.

13. A one-time password security token according to claim 8, wherein said communication means is selected from a group comprising: a display for displaying the password and thereafter manually providing the displayed value to said host, wired communication means with said host, wireless communication means with said host.

14. A one-time password security token according to claim 11, wherein said wired communication means further comprise means for providing a power supply to said security token.

15. A one-time password security token according to claim 8, further comprising a chargeable power source, to be charged by the power supplied by said communication means, for providing the power for operating said security token while not connected to said host.

16. A security system comprising:
at least one security token comprising: a one-time password mechanism, for rendering one-time password functionality; a public-key mechanism, for rendering public-key functionality with respect to said one-time password functionality; and communication means for connecting said security token to said host and for providing to said security token the power supply required for operating at least said public-key mechanism;
a host system, comprising: a one-time password mechanism, corresponding to the one-time password mechanism of said at least one security token, for rendering one-time password functionality; a public-key mechanism, corresponding to the public-key mechanism of said at least one security token, for rendering public-key functionality; communication means, corresponding to the communication means of said at least one security token, for communicating with said at least one security token and for providing to said token the power supply required for operating at least the public-key mechanism of said security token.

17. A system according to claim 16, wherein said communication means is selected from a group comprising: a display embedded within each of said at least one security token, for displaying the password and thereafter manually providing the displayed value to said host, wired communication means through which said at least one security token can be provided with the power supply required for performing public-key operations.

18. A system according to claim 16, wherein each of said at least one security token further comprising chargeable power source, to be charged via the power supply provided by said communication means, for providing the power for operating said at least one processor while not connected to said host, thereby enabling to operate said security token without external power supply.

19. A method for authenticating a client by a host system, said method comprising:
at said client side:
(a) generating a first one-time value;
(b) performing public-key functionality with respect to said one-time value;
(c) providing said value to said host system; at said host system side:
(d) performing public-key functionality which corresponds to the public key functionality performed at step (b) with the provided value;
(e) generating a second one-time value in substantially the same manner as said first one-time value is generated;
authenticating said client by the correspondence of said second value to said first value.

20. A method according to claim 19, wherein said public-key functionality with respect to said one-time value is selected from a group comprising: encrypting said one-time value, and digitally signing said one-time value.

21. A method according to claim 19, wherein said client is a security token.

22. A method according to claim 19, wherein providing the encrypted value to said host is carried out by a member of a group comprising: displaying said encrypted value at the client side and thereafter manually providing the displayed value to said host, means for connecting said security token to said host via a wired connection, and means for connecting said security token to said host via a wireless connection.
